(19) United States
(12) Patent Application Publication
(10) Pub. No.: US 2017/0312721 A1
(43) Pub. Date: Nov. 2, 2017

(54) REFORMING FURNACE COMPRISING REFORMING TUBES WITH FINS

(71) Applicant: L'Air Liquide, Société Anonyme pour I'Etude et I'Exploitation des Procédés Georges Claude, Paris (FR)

(72) Inventors: Fouad AMMOURI, Massy (FR); Daniel GARY, Montigny le Bretonneux (FR); Diana TUDORACHE, Versailles (FR)

(21) Appl. No.: 15/520,556

(22) PCT Filed: Sep. 18, 2015
(86) PCT No.: PCT/FR2015/052503

§ 371 Date: Apr. 20, 2017

(30) Foreign Application Priority Data
Oct. 21, 2014 (FR) 1460107

(51) Int. Cl. B01J 8/06; F28F 1/14; F28D 7/00; C01B 3/38

(52) U.S. Cl. CPC B01J 8/062; C01B 3/38; F28F 1/14; F28D 7/00; C01B 2203/0233; B01J 2208/00221; C01B 2203/0811; C01B 2203/0238

(57) ABSTRACT

A reforming furnace for producing hydrogen is provided. The reforming furnace includes a plurality of reforming tubes that allow a flow of hydrocarbons and at least one fluid inside the tubes, from top to bottom, and have, on at least part of the upper half of the outer surface at least one fin that has a thickness of between 1 and 30 mm, a width of between 3 and 100 mm, and a length of between 1 m and an length equivalent to the height of the furnace.

### CROSS REFERENCE TO RELATED APPLICATIONS

This application is a 371 of International PCT Application PCT/FR2015/052503 filed Sep. 18, 2015 which claims priority to French Patent Application No. 1460107 filed Oct. 21, 2014, the entire contents of which are incorporated herein by reference.

### BACKGROUND

The invention relates to a steam reforming furnace for the production of hydrogen, comprising a plurality of reforming tubes. The objective is to increase the transfer of total heat absorbed by the reforming tubes heated by radiation and convection, particularly in the upper part of the steam reforming furnace.

In these steam reforming furnaces, methane is reformed by steam at high temperatures (900-980° C.) and pressures comprised between 10 and 40 bars in reforming tubes filled with alumina-supported nickel catalyst. The decomposition reaction for methane is endothermic and requires an external heat source to initiate it. For this reason, the reaction generally takes place inside a combustion chamber equipped with burners by way of heating systems. These operating conditions place certain demands on the tube: specifically, the tubes made of refractory alloy need to be resistant to high-temperature oxidation and to creep. The operating conditions lead to a thermal profile with a significant gradient between the top (650/700° C.) and the bottom (900/950° C.) because of the endothermic reaction. In order to achieve such a temperature level, the reformers are designed with a wide variety of tube burner arrangements. The heat is transferred to the catalyst through the design of the tubes (cross section, length, thickness). A limiting step for the reforming reaction is the amount of heat supplied to the upper part of the reactor by the configuration of the existing tubes. In order to improve this disadvantage, an improvement to the current commercial tubes is proposed.

Numerous documents describe how to improve the transfer of heat in reforming tubes by placing a heat transfer structure inside the tube:
document US2013/0153188 proposes a heat transfer structure in thermal contact with the inside of the tube;
document U.S. Pat. No. 8,529,849 proposes a tube partially filled with at least one shape memory alloy element in order to increase the heat transfer coefficient. The shape memory alloy may deploy to remain in contact with the tube and fill the space between the tube and the catalytic bed;
document US2007/0297956 proposes a reactor filled with an extendable structure offering better heat transfer;
document US 2010/0038593 proposes a tubular reactor having a structure that leads to heat transfer by jet impact.

This collection of patents proposes to improve the heat transfers inside the tubes. This represents the following disadvantages for SMR furnaces: difficulty of filling and emptying catalyst into/out of the tubes; increase in the pressure drop inside the tubes as a result of the presence of the additional structures; risk of heterogeneity in the distribution of flow rate through the tube, gain in efficiency not as great as would be achieved with an external structure.

Other documents describe how to improve the heat transfer in reforming furnaces by placing a heat transfer structure on the outside of the tube. By way of example, document 2012/0251407 proposes installing fins on the external surface of the tubes but only in furnaces for the cracking of hydrocarbons of above 2 carbon atoms.

Finally, other documents (PCT/FR2008/050170 and FR1050645) propose the use of a conventional tubular reactor claiming an increase in metallic surface area by the addition of corrugations made in the thickness of the tube along the length of the reactor. These more extensive elements will increase the surface area for internal exchange between the internal surface of the tube and the catalytic material and therefore improve the efficiency of the heat transfer in the upper part of the tube. If additional surfaces are added to the internal wall of the tubes, the same disadvantages are encountered as in the case of the additional structures inside the tubes.

Taking that as a starting point one problem that arises is that of providing a steam reforming furnace that has tubes the configuration of which allows an increase in the heat absorbed.

### SUMMARY

One solution of the present invention is a steam reforming furnace for the production of hydrogen, comprising a plurality of reforming tubes allowing a flow of hydrocarbons and of at least one fluid inside the tubes from the top downward, and having, on their exterior surfaces, one or more fins, the majority of which is situated on at least part of the upper half, with the fins having a thickness comprised between 1 and 30 mm, a width comprised between 3 mm and 100 mm, and a length comprised between 1 m and a length equivalent to the height of said furnace (often 12 m). The chemical composition of the fin will be identical or very close to that of the tube (refractory alloy).

For preference, the thickness is comprised between 3 and 10 mm, the width comprised between 10 and 30 mm, the length comprised between 1 and 10 m.

Depending on circumstance, the steam reforming furnace according to the invention may have one or more of the features hereinbelow:
the number of fins per tube is comprised between 1 and 50, preferably between 2 and 26;
the fin may have the shape of a plate in the form of a rectangle, a trapezium, a triangular plate, a corrugated plate or a chamfered plate;
the fins are installed vertically;
the reforming tubes are installed in a combustion chamber;
the fluid flowing with the hydrocarbons inside the tubes is steam.

The fins are preferably welded to the coolest zones of the tube.

All the tubes are installed inside a combustion chamber. The fluid flowing in the reforming tubes is preferably a mixture of methane and of steam. Advantageously, the methane may contain a minimal quantity of H₂ (1 to 10% preferably 2 to 4%). This methane may also contain certain impurities such as CO₂ or nitrogen.

The exchanges of heat between the external environment and the upper part of each tube needs to be as high as possible because of the endothermic reactions:

steam methane reforming: CH₄+H₂ [symbol] CO+3H₂ΔH=205.8 kJ/mol
dry methane reforming: CH₄+CO₂ [symbol] 2CO+2H₂ΔH=246.9 kJ/mol

[symbol]

A significant amount of energy is therefore needed in order to quickly reach equilibrium.

In order to illustrate the role played by this invention, the gains in terms of improvement in heat transfer, have been evaluated using modeling tools, for various working configurations and various geometries. In what follows, only the case of parallelepipedal fins will be considered.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates the radial cross section of a tube having 4 parallelepipedal fins, in accordance with one embodiment of the present invention.

FIG. 2 illustrates the axial cross section of a tube, describing various parameters, in accordance with one embodiment of the present invention.

FIG. 3 illustrates an example of total heat transfer coefficient hₑₓₜ on the external surface of the tube and the equivalent ambient temperature also referred to as the incident temperature Tinc around the tube at the top of the furnace as a function of distance from the top of the furnace, in accordance with one embodiment of the present invention.

FIG. 4 illustrates the external tube temperature and the heat flux which as a function of the distance from the height of the furnace, in accordance with one embodiment of the present invention.

FIG. 5 illustrates the percentage of heat transfer relative to an infinite fin, as a function of wᵢₙ*m, in accordance with one embodiment of the present invention.

FIG. 6 illustrates the number of fins as a function of the increase in flux for three fin thicknesses, in accordance with one embodiment of the present invention.

FIG. 7 illustrates the number of fins as a function of the increase in flux for three fin thicknesses, in accordance with one embodiment of the present invention.

FIG. 8 illustrates the increase in tube weight caused by the fins (assumed over the entire length of the tube) in %, in accordance with one embodiment of the present invention.

FIG. 9 illustrates the ratio between the increase in heat flux due to the fins and the increase in tube weight is plotted as a function of thickness and for a fin width, in accordance with one embodiment of the present invention.

FIG. 10 illustrates the increase in tube temperature as a function of the number of fins 3 mm thick and 13.5 mm wide and for two different external flux values 101 kW/m² and 67 kW/m², in accordance with one embodiment of the present invention.

FIG. 11 illustrates the temperature profiles for a tube as a function of distance from the top of the furnace for the reference case “unfinned” and for the other two “finned” cases, in accordance with one embodiment of the present invention.

FIG. 12 illustrates an optimized composition of the number of fins, the fins increasing the tube temperature in the upper part of the furnace and stabilize it in the lower part, in accordance with one embodiment of the present invention.

### DESCRIPTION OF PREFERRED EMBODIMENTS

FIG. 1 gives an example of a cross section of a tube having 4 parallelepipedal fins.

The fins are generally used to increase the surface area for heat exchange in heat exchangers. In order to obtain the maximum gain in heat with fins, it needs to be installed on the side of the heat exchanger on which the thermal resistance is the highest.

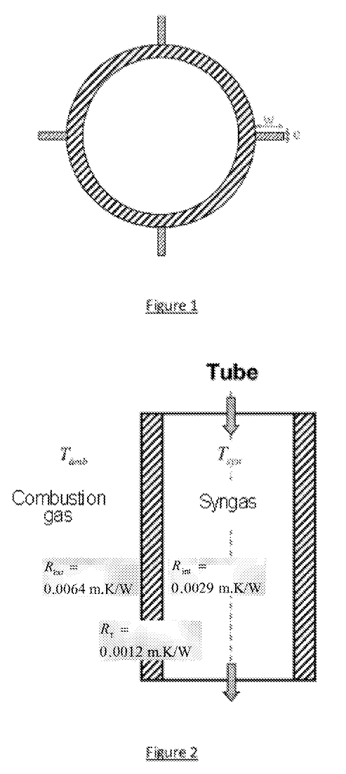

In the case of steam reforming furnaces, the thermal resistance Rₑₓₜ on the external side of the tube is the highest (0.0064 mK/W) with respect to the conduction resistance Rₜ of the wall of the tube (0.0012 mK/W) and the thermal resistance Rᵢₙₜ between the internal surface of the tube and the syngas (0.0029 mK/W) (FIG. 2).

$${R}_{ext} = \frac{1}{π {D}_{ext} {h}_{ext}} = 0.0064 m . K / W$$

$${R}_{t} = \frac{1}{2 π {λ}_{t}} ln ( \frac{{D}_{ext}}{{D}_{int}} ) = 0.0012 m . K / W$$

$${R}_{int} = \frac{1}{π {D}_{int} {h}_{int}} = 0.0029 m . K / W$$

where Dₑₓₜ and Dᵢₙₜ are respectively the external and internal diameter of the tube, λt is the thermal conductivity of the tube wall and hₑₓₜ and hᵢₙₜ are respectively the heat transfer coefficients on the external and internal side of the tube.

Next, the total thermal resistance between the combustion gases and the syngas is the sum of the three resistances:

Rₜₒₜ=Rₑₓₜ+Rₜ+Rᵢₙₜ=0.0064±0.0012+0.0029-0.0105 m.K/M

In fact, the external thermal resistance Rₑₓₜ represents approximately 61% of the total thermal resistance Rₜₒₜ and is twice as high as the internal thermal resistance Rᵢₙₜ. Specifically, if the heat transfer coefficient hₑₓₜ, is doubled the external thermal resistance Rₑₓₜ will be reduced by half and the total resistance Rₜₒₜ by 31%. However, if the heat transfer coefficient hᵢₙₜ, is doubled, then Rᵢₙₜ is reduced by half and Rₜₒₜ is reduced by just 14% rather than by 31% as in the first instance.

Therefore, in order to obtain the maximum effect on the total transfer of heat between the combustion gases and the syngases, the fins need to be installed on the external surface of the tube as shown in FIG. 1, which provides an example of the installation of four parallelepipedal fins.

The “fin” approach will be used in what follows and is based on the approximation that the temperature profile along the thickness of the fin is near uniform with respect to the temperature profile along the width of the fin. This approximation is valid if the Biot number is less than one. The Biot number for a rectangular fin is defined by:

$$Bi = \frac{{h}_{f} e}{2 {λ}_{f}}$$

where h_{f} is the total heat coefficient (for radiation and convection) between the fin and the ambient temperature around the fin and λ_{f} is the thermal conductivity of the fins. It is assumed that the heat transfer coefficient around the fin is exactly the same as that around the tube and the fin.

h_{f}≈hₑₓₜ and λ_{f}=λₜ

In reforming furnaces in which the external heat coefficient hₑₓₜ is approximately 400 W/m2.K and the thermal conductivity of the fins λ_{f} is 30 W/m.K, as long as the thickness e of the fins is less than 15 mm, the Biot number is less than 0.1 and the approximation is valid. In what follows, we shall be considering that this condition is met. In this case, the temperature profile along the width of the fin is only 1-dimensional (1-D). The temperature profile along the width of the fin (profile with x in co-ordinate with x=0 the base of the tube) is expressed by:

$$\frac{T ( x ) - {T}_{amb}}{T ( 0 ) - {T}_{amb}} = \frac{( 1 + \frac{{λ}_{f} m}{{h}_{f}} ) exp ( m ( w - x ) ) - ( 1 - \frac{{λ}_{f} m}{{h}_{f}} ) exp ( - m ( w - x ) )}{( 1 + \frac{{λ}_{f} m}{{h}_{f}} ) exp ( mw ) - ( 1 - \frac{{λ}_{f} m}{{h}_{f}} ) exp ( - mw )}$$

This formulation is based on the assumption that the temperature at the base of the fin is not altered by the presence of this fin.

In order to choose optimal dimensions for the fins, we are going to introduce the fin parameter referred to as m (dimension m⁻¹) for a constant zone of the cross section of the fin defined by:

$$m = \sqrt{\frac{{h}_{f} P}{{λ}_{f} {A}_{c}}} \approx \sqrt{\frac{{h}_{ext} P}{{λ}_{t} {A}_{c}}}$$

Where P is the perimeter of the cross section of the fin and A_{c} is the cross-sectional area of the fin.

In reforming furnaces, the radiation of heat from the combustion gases and from the walls of the furnace represents 95% of the total heat flux on the tubes. Thus, in what follows, the convective heat flux on the tubes will be neglected in favor of the radiation heat flux.

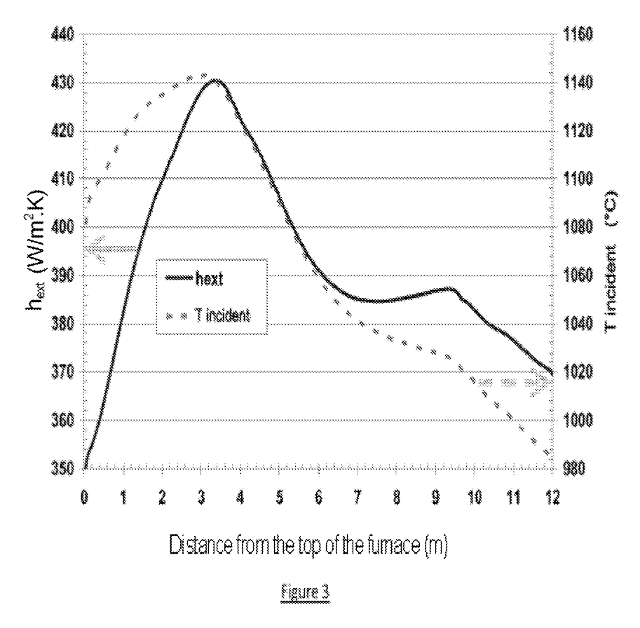

FIG. 3 shows an example of total heat transfer coefficient hₑₓₜ on the external surface of the tube and the equivalent ambient temperature also referred to as the incident temperature Tinc around the tube at the top of the furnace as a function of distance from the top of the furnace.

The incident temperature is calculated using the following relationship and knowing the total heat flux and the temperature on the outside of the tube inside the furnace:

$${ϕ}_{t} = {ϕ}_{r} + {ϕ}_{conv} \approx {ϕ}_{r} = ɛ ( {ϕ}_{inc} - σ {T}^{4} ) = ɛ ( σ {T}_{inc}^{4} - σ {T}^{4} ) {T}_{inc} = {( \frac{{ϕ}_{t} + ɛ σ {T}^{4}}{ɛ σ} )}^{1 / 4}$$

Where φ₁, φᵣ and φ_{conv} are respectively the total heat flux, the heat flux by radiation and the heat flux by convection on the tube, ε is the external emissivity of the tube, σ is the Stefan-Bolztmann constant (5.67 10⁻⁸ S.I.) and T is the external temperature of the tube in Kelvin.

If we assume that the total heat flux of the flux can be linearized then a total heat transfer coefficient on the external surface of the tube as follows:

$${h}_{ext} = \frac{{ϕ}_{t}}{{T}_{inc} - T}$$

can be introduced.

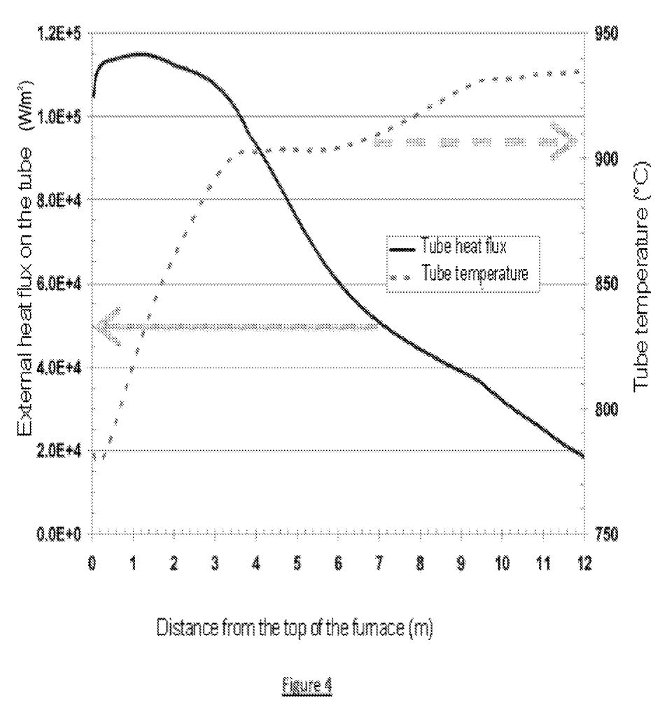

The mean value for hₑₓₜ along the entire height of the tube is 393 W/m2 and the mean value for the ambient or incident temperature is 1066° C. These results were obtained from 3-D numerical fluid dynamic calculations (Computational Fluid Dynamics) inside the reforming furnace as the external tube temperature and the heat flux which are displayed in FIG. 4 as a function of the distance from the height of the furnace.

For a parallelepipedal fin of width w, of thickness e and of length L, we have the ratio of the perimeter of the fin to the cross-sectional area of the fin equal to:

$$\frac{P}{{A}_{c}} = \frac{2 ( L + e )}{Le} \approx \frac{2 L}{Le} = \frac{2}{e}$$

Because the thickness of the fin is very small in comparison with its length, the parameter m of the fin is practically independent of its length.

$$e << L ⇒ m \approx \sqrt{\frac{2 {h}_{ext}}{{λ}_{t} e}}$$

The greater the distance between the base of the fin and another point on the fin, the closer the temperature of the fin at this point comes to the ambient temperature and the less useful the fin becomes from this distance onward. The fin width should therefore be less than a certain limit determined by the following equation:

$${w}_{lim} = \frac{2.65}{m}$$

This limit size wₗᵢₘ of the fin corresponds to 99% of the maximum heat acquired by an infinite fin. It may be pointed out that for half of this limit size

$$( {w}_{lim \text{/} 2} = \frac{{w}_{lim}}{2} = \frac{1.325}{m} )$$

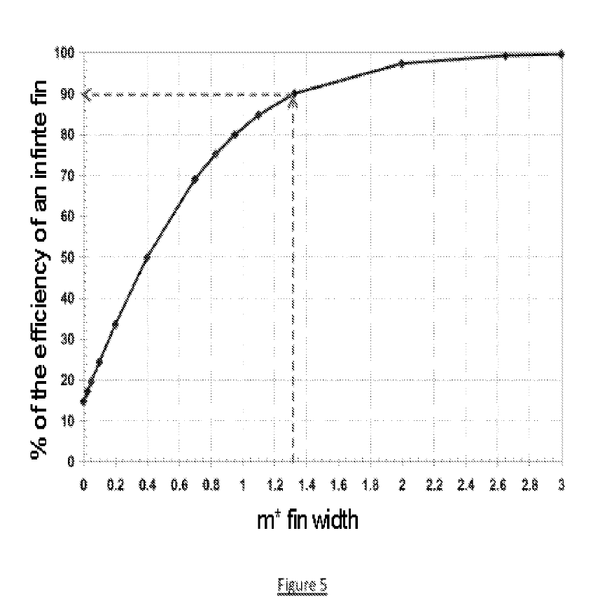

we already have 90% of the heat acquired by an infinite fin (see FIG. 5). These results were confirmed by 2-dimensional (2-D) numerical calculation.

In what follows, we are going to restrict the width of the fin to this limit in order to reduce the weight of the tube (with fins) while at the same time keeping the gain in heat close to the maximum.

In order to choose the number of fins to install on a tube, we are going first of all to introduce the fin efficiency parameter η_{f} which is defined as the ratio of the heat flux transferred through a fin φ_{f} and that transferred over the same surface without a fin φₜ:

$${η}_{f} = \frac{{Φ}_{f}}{{Φ}_{t}} = \frac{{- {λ}_{f} \frac{dT}{dx} \vert}_{x = 0}}{{h}_{ext} ( T ( x = 0 ) - {T}_{amb} )} = \frac{{λ}_{f} m}{{h}_{f}} [ \frac{( 1 + \frac{{λ}_{f} m}{{h}_{f}} ) exp ( m w ) + ( 1 - \frac{{λ}_{f} m}{{h}_{f}} ) exp ( - m w )}{( 1 + \frac{{λ}_{f} m}{{h}_{f}} ) exp ( mw ) - ( 1 - \frac{{λ}_{f} m}{{h}_{f}} ) exp ( - mw )} ]$$

Maximum fin efficiency is obtained when the fin width is infinite (w→∞ or m w≧3). In this case, the fin efficiency becomes:

$${η}_{fmax} = {η}_{f} ( w \to ∞ or mw \geq 3 ) = \frac{{λ}_{f} m}{{h}_{f}}$$

Note that

$$\frac{{η}_{f}}{{η}_{fmax}}$$

is represented in FIG. 5 as a function of mw.

Next, we are going to use the finned tube efficiency η_{tf} defined as the ratio between the heat flux transferred to a tube equipped with fins, φ_{tf} and the heat flux transferred to a tube without fins, φₜ (bare tube).

$${η}_{tf} = \frac{{Φ}_{tf}}{{Φ}_{t}}$$

For a 1-D approach and assuming the tube external wall temperature to be constant, we obtain:

$${η}_{tf} = \frac{{η}_{f} {n}_{f} e + ( π {D}_{ext} - {n}_{f} e )}{π {D}_{ext}} = 1 + \frac{( {η}_{f} - 1 ) {n}_{f} e}{π {D}_{ext}}$$

Where n_{f} is the number of fins on the perimeter of the tube.

The efficiency of the finned tube can be determined by 2-D numerical conduction calculation with boundary limits inside the tube. That means that the temperature at the base of the fin is not fixed.

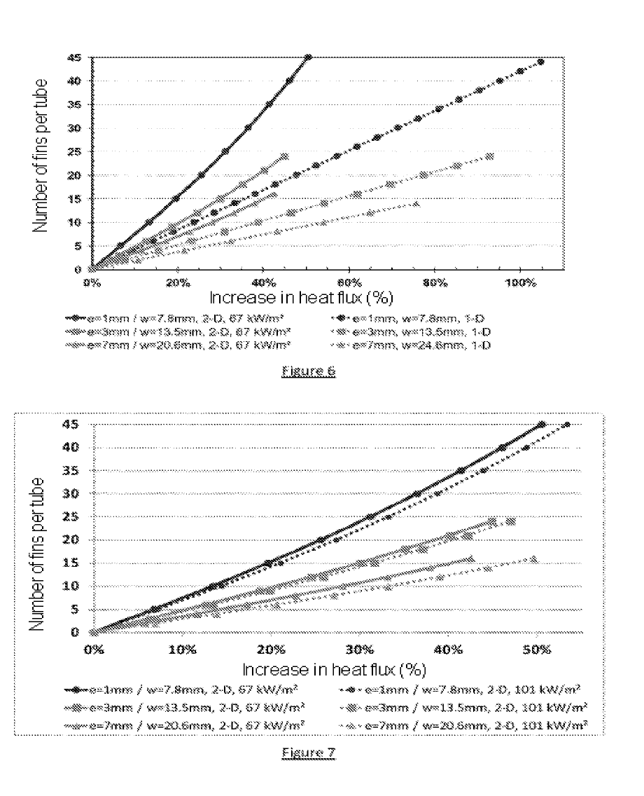

FIGS. 6 and 7 show the number of fins as a function of the increase in flux for three fin thicknesses: 1 mm, 3 mm and 7 mm, with a fin width respecting the criterion

$$w = {w}_{lim / 2} = \frac{1.325}{m} .$$

FIG. 6 compares the two, 1-D and 2-D, calculation approaches. Since the 1-D approach considers that the temperature at the base of the fin is constant, the increase in flux, with the same number of fins, is overestimated in comparison with the 2-D approach. Hereinafter, it is the 2-D approach that will be used as a basis as this is closer to reality.

FIG. 7 compares the efficiency of the tube for two different tube external flux conditions: 101 kW/m², a characteristic value for the region of the tube near the upper part of the furnace; and 67 kW/m2, a characteristic value for the middle of the tube in the heightwise direction. For the same number of fins having the same characteristics, the efficiency of the finned tube varies slightly with flux. It may be noted that the greater the external flux, the greater the gain in efficiency. The efficiency of the finned tube varies significantly with fin characteristics. For the same number of fins, the thicker the fin, the more tube efficiency increases, but the tube weight will be higher.

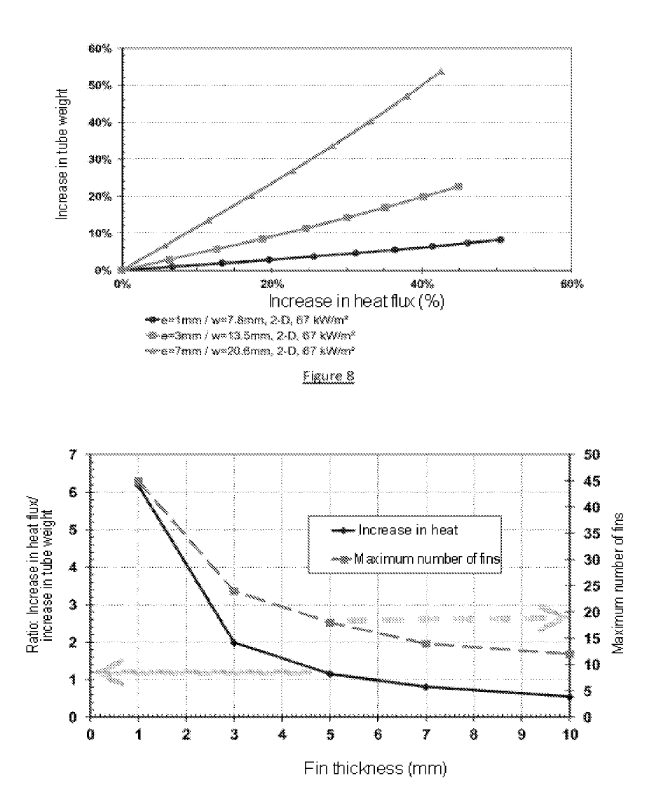

FIG. 8 shows the increase in tube weight caused by the fins (assumed over the entire length of the tube) in %, which is equal to the ratio:

$$\frac{weight of fins}{weight of tube} in \% = 100 ⋆ \frac{{n}_{f} ew}{π \frac{( {D}_{ext}^{2} - {D}_{int}^{2} )}{4}}$$

The increase in the weight of the tube is displayed as a function of the increase in heat flux in % (equal to 100*(η_{tf}−1)) for three fin thicknesses 1 mm, 3 mm and 7 mm and for a fin width respecting the criterion

$$w = {w}_{lim / 2} = \frac{1.325}{m} .$$

It may be seen that, for the same increase in flux, the thicker the fin the greater the increase in tube weight.

In FIG. 9, the ratio between the increase in heat flux due to the fins and the increase in tube weight is plotted as a function of thickness and for a fin width defined by

$$w = {w}_{lim / 2} = \frac{1.325}{m} .$$

This shows that the thinner the fin, the greater the heat picked up by the tube for a given increase in tube weight. This is due to the fact that a thinner fin has a larger exchange surface.

Another limit on the number of fins is the minimal distance between two fins. This distance needs to be at least equal to the width of a fin in order to leave enough space for radiation (radiation is the predominant way in which heat is transferred to the tubes) from the walls of the furnace and from the combustion gases to heat the tube and the fins. In this case, the maximum number of fins that can be placed on a tube is equal to:

$${n}_{fmax } = \frac{π {D}_{ext}}{w + e}$$

Accordingly, the number of fins on a tube must always be less than or equal to this limit (n_{f}≧n_{f}).

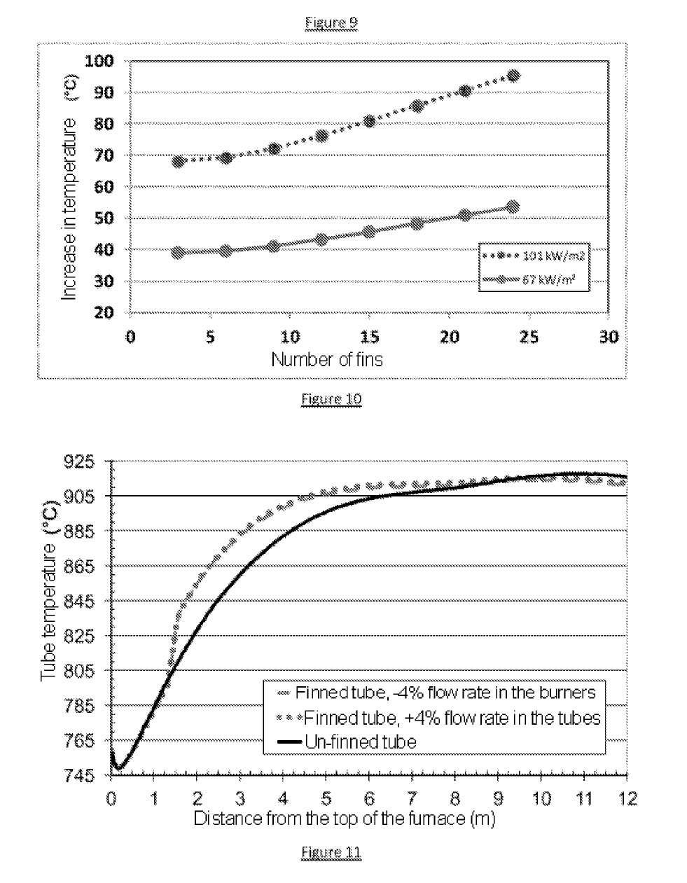

Because the fins improve the heat flux picked up by the tube, the tube temperature is increased. As a result, it is necessary using numerical modeling to check that the surface temperature of the finned tube does not exceed the MOT (Maximum Operating Temperature), particularly in the lower part of the reforming furnace where the tube temperatures are already close to the MOT. To illustrate that, FIG. 10 shows the increase in tube temperature as a function of the number of fins 3 mm thick and 13.5 mm wide and for two different external flux values 101 kW/m² and 67 kW/m². It may be seen that the flux has a significant impact on this increase in temperature.

In order to determine the effect that the fin has on the thermal efficiency of the reforming furnace, 1-D numerical calculations coupled between heat transfer in the combustion chamber and heat transfer inside the tubes were performed.

It was shown that the thermal efficiency of the furnace can be increased up to 3.5%. This was achieved with a variable number of fins per tube depending on the height of the tube. The objective is to maximize the total heat flux absorbed by each tube while keeping the maximum tube temperature below the MOT and avoiding the formation of carbon in the upper part of the tubes.

The increase in the efficiency of the furnace can be used either to increase the supply to the tube and the production of hydrogen up to 3.9% with the same burner power or to reduce the burner power by as much as 4.2% for the same hydrogen production. All this is done while keeping the outlet temperature of the syngas furnace constant.

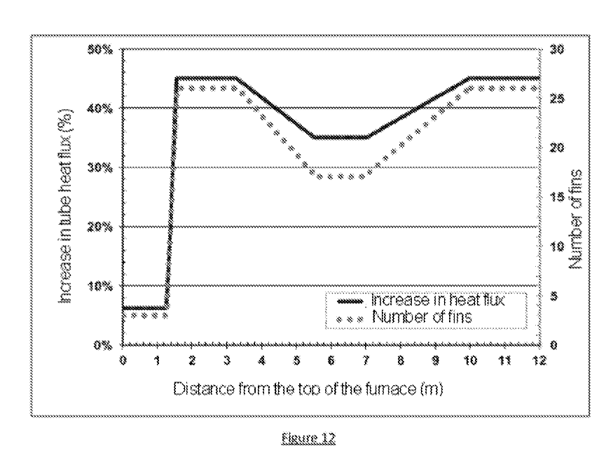

In FIG. 11, the temperature profiles for a tube as a function of distance from the top of the furnace are displayed for the reference case “unfinned” and for the other two “finned” cases (first case: choice to increase production and second case: choice to reduce burner power). It may be seen that with an optimized composition of the number of fins (FIG. 12), the fins increase the tube temperature in the upper part of the furnace and stabilize it in the lower part. This example relates to a furnace 12 m tall, 19 m long and 17 m wide containing 400 tubes. Each tube of this furnace will be equipped with 3 fins over a height comprised between 0 and 1.5 m, 26 fins between 1.5 m and 3.3 m, 17 fins between 5.5 m and 7 m and 26 fins between 10 m and 12 m. The transition zones will have a constant number of fins in increments of 0.3 m.

The circumferential position of the fins on the tube may also be optimized to even out the temperature profile at a given height.

Another way of benefiting from the increase in furnace efficiency caused by the fins of the tube is to modify the design of the furnace for a given production by reducing the height of the furnace by as much 3.5% or by reducing the number of tubes in this same furnace. It may also be advantageous to combine these latter two possibilities, but with a lower percentage reduction for each.

All of the results given hereinabove correspond to a rectangular fin shape.

Similar results were recorded for fins with trapezoidal or triangular cross sections confirming the advantages of these shapes of fins in improving the heat transfer to the tubes.

In conclusion, the optimum dimensions for the fins of the tubes of reforming furnaces, which may themselves have a variable height, are defined in the range:
thickness between 1 and 30 mm;
width between 3 and 100 mm;
length comprised between 1 m and a length equivalent to the height of the furnace;
number of fins per tube comprised between 1 and 50.

Further, the reforming furnace according to the invention is preferably used for production of hydrogen.

Finally note that the fins may be fixed to a reforming tube by welding or by casting or by additive manufacturing.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-7. (canceled)

8. A reforming furnace for the production of hydrogen, comprising a plurality of reforming tubes allowing a flow of hydrocarbons and of at least one fluid inside the tubes from the top downward, and having, on their exterior surfaces, one or more fins, the majority of which is situated on at least part of the upper half, with the fins having a thickness comprised between 1 and 30 mm, a width comprised between 3 mm and 100 mm, and a length comprised between 1 m and a length equivalent to the height of said furnace.

9. The reforming furnace of claim 8, wherein the number of fins per tube is comprised between 1 and 50.

10. The reforming furnace of claim 8, wherein the fin may have the shape of a plate in the form of a rectangle, a trapezium, a triangle, a corrugated plate or a chamfered plate.

11. The reforming furnace of claim 8, wherein the fins are installed vertically.

12. The reforming furnace of claim 8, wherein the fluid flowing with the hydrocarbons inside the tubes is steam.

13. The reforming furnace of claim 8, wherein the reforming tubes are installed in a combustion chamber.

14. The use of a reforming furnace of claim 8 for the production of hydrogen.
